(19) United States
(12) Patent Application Publication
(10) Pub. No.: US 2026/0351864 A1
(43) Pub. Date: Nov. 5, 2026

(54) TWIST-ON ELECTRICAL CONNECTOR SPRING

(71) Applicant: IDEAL Industries, Inc., Sycamore, IL (US)

(72) Inventors: Robert W. Sutter, DeKalb, IL (US); Naomi N. Cross, Wheaton, IL (US); Brendan G. Metz, Saint Charles, IL (US); Anthony van Roon, Oshawa (CA)

(21) Appl. No.: 19/664,134

(22) Filed: Apr. 30, 2026

Related U.S. Application Data
(60) Provisional application No. 63/798,231, filed on May 1, 2025.

(51) Int. Cl. H01R 4/12; H02G 15/04

(52) U.S. Cl. CPC H01R 4/12; H02G 15/043

(57) ABSTRACT

A twist-on wire connector for joining ends of a plurality of electrical wires includes an insulating shell having a body wall and an end wall with internal surfaces defining an internal cavity with an opening for receiving the electrical wires, and a spring mounted in the internal cavity and engaging the internal surface of the body wall. The spring includes a wound metal wire having a non-circular cross-section.

### CROSS-REFERENCE TO RELATED APPLICATION

This application claims the benefit of priority to provisional application no. 63/798,231, filed on May 1, 2025, which application is hereby incorporated by reference in its entirety.

### TECHNICAL FIELD

This disclosure generally relates to wire connectors, including screw-on or twist-on wire connectors which require less material.

### BACKGROUND

Twist-on wire connectors are widely used in the electrical trades for joining electrical wires. Twist-on connectors are adapted to be screwed onto the stripped ends of electrical wires. These types of connectors typically have a shell or cap made of an insulating material, such as plastic. The shell is shaped for easy manipulation. For example, the exterior surface of the shell may have raised ribs, protrusions or wings to facilitate gripping and/or turning. The exterior surface may also include features to reduce slippage when twisting the connectors on by hand. The exterior may further be adapted to accommodate the use of hand tools, such as wrenches and pliers, or tool chucks so that power tools could be used to perform the installation.

The interior surface of the shell typically has a generally conically-shaped bore or cavity with a larger opening at the point of entry of the stripped electrical wires. The cavity typically tapers towards a closed end. Seated within the shell's cavity is a coiled metal wire commonly referred to as a spring. The outer contour of the spring may generally match the conically-shaped interior surface of the shell. Thus, the spring has a larger opening at the electrical wire receiving end and a smaller opening adjacent the closed end portion of the shell. The spring also defines an internal cavity which receives the electrical wires therein.

The spring facilitates the holding or gripping of the stripped ends of electrical wires in order to maintain contact between the electrical wires. The spring also grips the interior surface of the shell to prevent it from becoming detached and leaving the bare electrical wires exposed.

### BRIEF DESCRIPTION OF THE DRAWINGS

FIG. 1 is a longitudinal cross-sectional view of a twist-on wire connector.

FIGS. 2a and 2b are enlarged cross-sectional views of a single coil of a round spring and a rectangular spring, respectively.

FIGS. 3a-3g are enlarged cross-sectional views of respective shapes of a wire for a spring.

FIGS. 4-14 are cross-sectional views of springs having respective cross-sectional wire shapes.

### DETAILED DESCRIPTION

The cross-sectional shape of the wire used to form the spring is important to providing secure engagement with the stripped electrical wire ends and the interior surface of the shell. Presently, the most common cross-sectional shape is square or circular. The spring is oriented in the shell so that one comer or crest of this cross-sectional shape extends toward the inner surface of the shell. When the spring is inserted into the shell during manufacture of the connector the crest will grip the inner surface of the shell securely, thereby locking the spring and shell together. The opposite corner or crest of the spring wire's cross-sectional shape faces the cavity of the spring, positioning this crest for engagement with an electrical wire inserted into the connector. In this manner, each winding or coil of the spring presents a crest which can bite into the stripped ends of the wires in order to provide adequate fixation of the connector to the electrical wires.

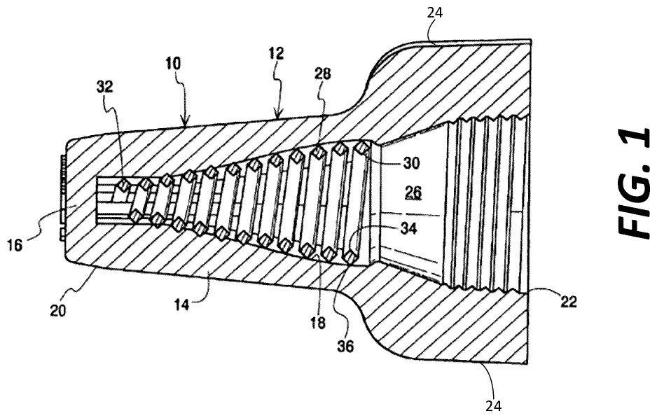

FIG. 1 is a side cross-sectional view of an example twist-on or screw-on wire connector 10. It includes an insulating shell 12 having a body wall 14 and an end wall 16. The shell is typically made of plastic. The body wall has an internal surface 18 and an external surface 20. The external surface is generally conical in shape and extends from an opening 22 at the larger end to the integral end wall 16 at the small end. The large end may also have opposing wings 24 to provide leverage when turning the connector onto the stripped ends of electrical wires. The internal surface 18 defines a generally conical shaped cavity 26 which extends from the opening 22 and tapers toward the inner surface of the end wall 16. The internal surface 18 may optionally be threaded at the large end to assist in gripping the insulation of an electrical wire.

A spring 28 is shown in cavity 26. The spring 28 is formed from a plurality of coils or windings of a metal wire and tapers from a large diameter end 30 near the opening 22 to a smaller diameter end 32 near the end wall 16. The taper of the spring may generally match the conical shape of the internal surface 18. Although the spring in FIG. 1 is in the form of an open helix where the windings do not overlap or abut each other, it can also be in the form of a closed helix where the windings do overlap or abut each other.

The coils of the spring 28 in FIG. 1 have a conventional square cross-sectional shape. The coils are arranged so that one corner 34 of the cross-sectional shape projects into the interior space or cavity defined by the spring itself. This cavity receives the stripped ends of wires to be joined. The opposing corner 36 penetrates the inner surface 18 of the shell to retain the spring in the shell. Although the corners 34, 36 of the square cross section are shown to meet at a sharply defined right angle, this will not always be the case since it is difficult to form wire of this size with truly sharp edges or corners. Generally, the comer has a rounded or radiused surface.

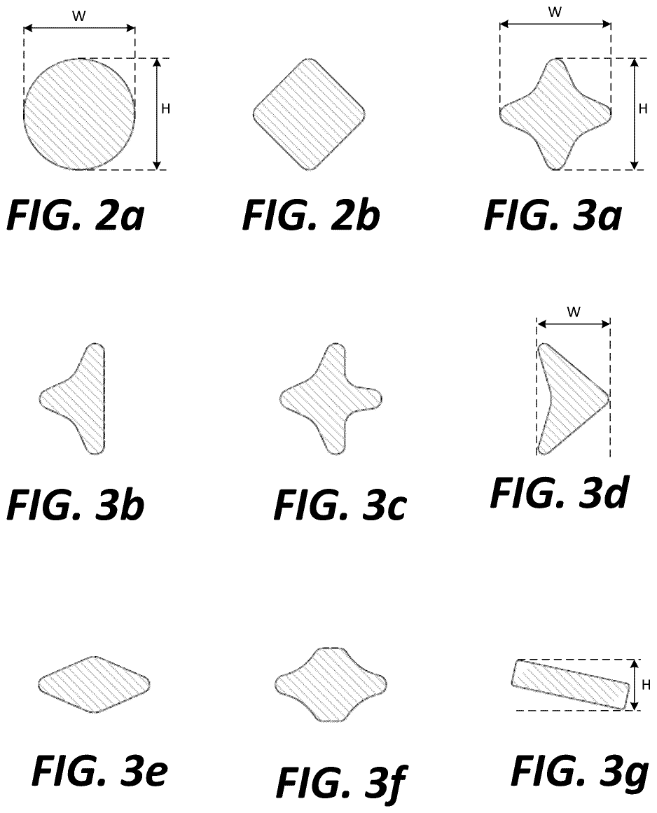

FIGS. 2a-3g illustrate various cross-sectional spring shapes, shown diagrammatically from an end of the spring. Any of the shapes of FIGS. 2a-3g may be used in place of the spring 28.

FIGS. 2a and 2b illustrate two spring shapes. In particular, FIG. 2a illustrates a circular spring, and FIG. 2b illustrates a rounded-edge rectangular spring. Both of these shapes have relatively large surface areas, and thus require a relatively large amount of material. Cross-sectional spring shapes having smaller cross-sectional areas may require less material to produce and thus may provide more efficient designs.

FIGS. 3a-3g illustrate spring shapes (that is, the cross-sectional shape of the wire forming the spring) having relatively smaller cross-sectional areas that require less material to produce. The shapes are described in detail below. In general, each of the spring shapes of FIGS. 3a-3g includes radial asymmetry (e.g., FIGS. 3b-3d), bilateral asymmetry (e.g., FIGS. 3b-3d, 3g), at least one concave portion (e.g., FIGS. 3a-3d, 3f), and/or a height that is different from the width of the spring (e.g., FIGS. 3b, 3d-3g).

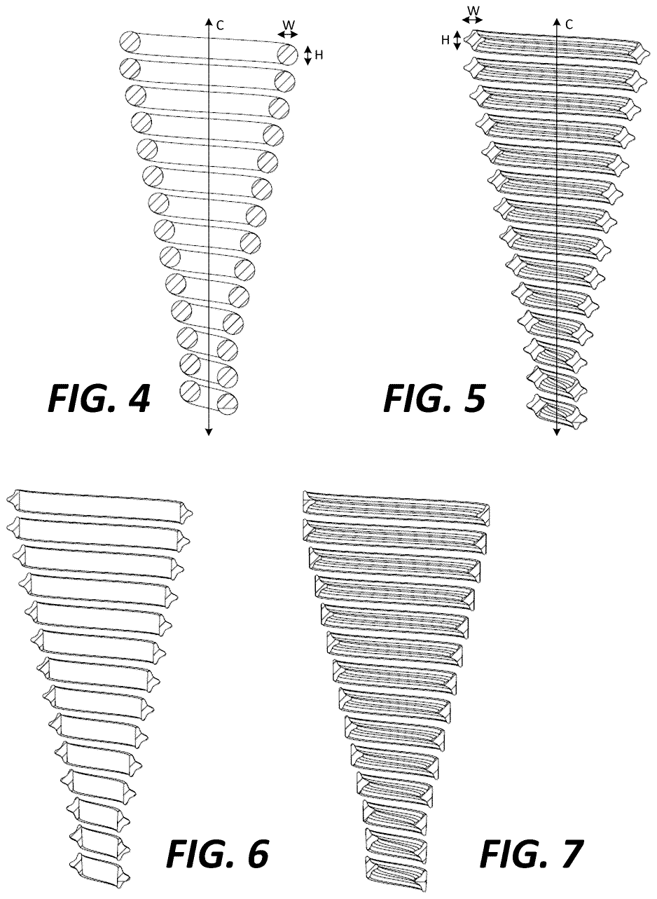

As used herein, the cross-sectional shape of a coil or wire refers to a cross-section taken orthogonal to the length of the wire and parallel to the centerline C of the spring (labelled in FIGS. 4 and 5. FIGS. 1-14 illustrate such cross-sections. Bilateral asymmetry refers to asymmetry across a vertical bisection line (e.g., a bisection line that is parallel to centerline C). The height of the wire refers to the dimension parallel to the centerline of the conical shape, and width of the wire refers to the dimension perpendicular to the centerline. The height H and/or width W are labelled in FIGS. 2a, 3a, 3d, and 3g but are applicable to each embodiment herein. The height H and width W refer to the height and width of the entire cross-section of the wire (i.e., where width is from left-most point to right-most point, and height is from lowermost point to uppermost point), as shown in the labelled figures.

FIG. 3a illustrates a star-shaped spring. The cross-sectional shape of the spring resembles a four-pointed star with concave recesses between points, with each point extending outward symmetrically from the center. The points are rounded rather than sharply defined, giving the star a smooth and contoured outer profile. This design provides multiple protrusions for engaging the stripped ends of electrical wires and the interior surface of the shell, while minimizing the amount of material required to produce the spring.

FIG. 3b illustrates a half star-shaped spring. The cross-sectional shape of the spring resembles a portion of a star, with a linear side extending substantially an entire width of the spring and a rounded point extending from concave recesses opposite the linear side. The ends of the linear side may be rounded and have a substantially similar contour as the rounded point opposite the linear side. This design provides protrusions on one side for engaging the stripped ends of electrical wires and the interior surface of the shell, while using less material compared to a full star-shaped spring.

FIG. 3c illustrates an arrowhead-shaped spring. The cross-sectional shape of the spring resembles an arrowhead, with a pointed tip extending outward symmetrically from the center and broader, rounded edges tapering back toward the base. The arrowhead shape may be substantially similar to the half star shape, but with the linear side interrupted by an outward-extending lobe at its center. The lobe may extend outward less than the rounded point opposite the lobe. The lobe and the pointed tip may extend away from concave recesses. Further, the lobe may be narrower than the rounded point opposite the lobe. This design provides a sharp protrusion for engaging the stripped ends of electrical wires and the interior surface of the shell, while maintaining a streamlined profile to minimize the amount of material required to produce the spring.

FIG. 3d illustrates a shark tooth-shaped or boomerang-shaped spring. The cross-sectional shape of the spring resembles a shark tooth or boomerang, featuring a pointed tip between two sides that are substantially perpendicular to one another. A concave side may be opposite the pointed tip. This design provides a sharp protrusion for securely engaging the stripped ends of electrical wires and the interior surface of the shell.

FIG. 3e illustrates a rounded-edge diamond-shaped spring. The cross-sectional shape of the spring resembles a diamond with rounded, instead of pointed, edges. The diamond includes four linear sides, with adjacent linear sides meeting at a rounded edge. The diamond includes a height extending from a first, lower rounded edge to an opposed second, upper rounded edge, and a width extending from a third rounded edge to an opposed fourth rounded edge. The height is perpendicular to, and a different length than, the width. In the embodiment shown, the width is greater than the height, but in other embodiments the height may be greater than the width.

FIG. 3f illustrates a nub-ended star-shaped spring. The cross-sectional shape of the spring is the same as the star of FIG. 3a, but two opposed points are abbreviated into shorter nubs with substantially flat ends. This design enhances gripping efficiency by offering multiple contact points for engaging the stripped ends of electrical wires and the interior surface of the shell, while minimizing the amount of material required to produce the spring.

FIG. 3g illustrates an elongated rectangle-shaped spring. The cross-sectional shape of the spring resembles a narrow, rectangular bar with smooth, straight edges. The rectangle includes four sides, with two opposed sides being shorter than the other set of opposed sides. The corners may bite into the stripped ends of the electrical wires.

FIG. 4 illustrates a spring formed from a wire having the circular cross-sectional shape shown in FIG. 2a. In the illustrated embodiment, the spring is wound into a tapered helix extending from a larger diameter end toward a smaller diameter end so that the spring can be received within a generally conical cavity of a twist-on wire connector shell. Because the wire has a circular cross section, the spring presents a smooth outer engagement profile to the shell and a smooth inner engagement profile to stripped ends of electrical wires received within the spring. A spring of this type can provide reliable retention and wire engagement, although the circular cross section generally includes more material than the reduced-area shapes described below.

FIG. 5 illustrates a spring formed from a wire having the star-shaped cross-sectional shape shown in FIG. 3a. The wire is wound so that respective outwardly directed portions of the star-shaped cross section are positioned to engage an internal surface of the shell, while opposed inwardly directed portions project toward a cavity of the spring for engagement with stripped ends of electrical wires. Because the star-shaped cross section includes multiple rounded points and intervening concave regions, the spring can provide multiple localized contact regions while reducing material relative to a circular or square cross section.

FIG. 6 illustrates a spring formed from a wire having the half star-shaped cross-sectional shape shown in FIG. 3b. The half star shape includes a substantially linear side and an opposed rounded point, and the wire can be wound such that the rounded point is positioned to project toward the cavity of the spring or toward the shell, depending on the desired engagement characteristics. In one configuration, the rounded point is oriented inwardly to provide a concentrated contact region for biting into stripped wire ends, while the opposite side provides support against the shell.

FIG. 7 illustrates a spring formed from a wire having an inverted half star-shaped cross-sectional shape corresponding to FIG. 3b. Relative to FIG. 6, the half star shape is reversed so that the previously inwardly directed feature is outwardly directed, or vice versa. This inverted orientation may alter which portion of the wire preferentially engages the shell and which portion preferentially engages the stripped wire ends, thereby providing an additional design option for balancing shell retention, wire gripping, and material usage.

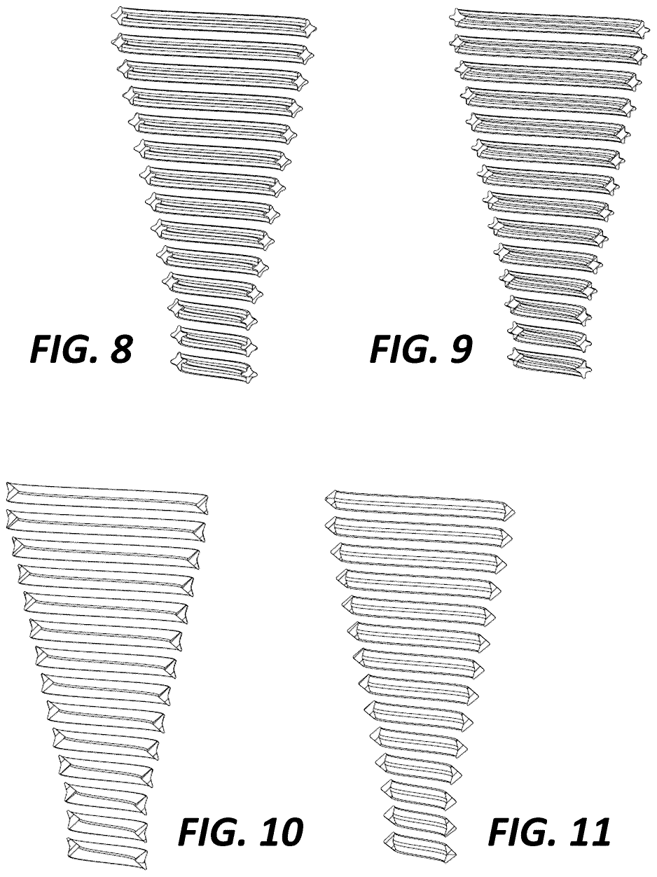

FIG. 8 illustrates a spring formed from a wire having the arrowhead-shaped cross-sectional shape shown in FIG. 3c. The arrowhead-shaped cross section includes a more prominent rounded point on one side and a smaller outward-extending lobe on an opposite side. The wire can be wound so that the more prominent rounded point projects toward the cavity of the spring to engage stripped wire ends, while the opposite lobe and adjoining surfaces engage the internal surface of the shell. The streamlined arrowhead-shaped profile can provide effective gripping with less material than a circular or rectangular cross section.

FIG. 9 illustrates a spring formed from a wire having an inverted arrowhead-shaped cross-sectional shape corresponding to FIG. 3c. In this embodiment, the arrowhead-shaped profile is reversed relative to FIG. 8 so that the larger rounded point and the smaller lobe exchange inward and outward orientations. This arrangement can be selected to modify the aggressiveness of engagement with the stripped wire ends and the shell while still using a reduced-area wire profile.

FIG. 10 illustrates a spring formed from a wire having the shark tooth-shaped or boomerang-shaped cross-sectional shape shown in FIG. 3d. The cross section includes a pointed tip between two sides that are substantially perpendicular to one another, with a concave side opposite the pointed tip. The wire can be wound so that the pointed tip projects toward the cavity of the spring to provide a pronounced contact feature for gripping stripped wire ends, while an opposite portion of the cross section engages the shell.

FIG. 11 illustrates a spring formed from a wire having an inverted shark tooth-shaped or boomerang-shaped cross-sectional shape corresponding to FIG. 3d. Relative to FIG. 10, the cross-sectional profile is reversed so that the pointed tip is directed opposite the orientation shown in FIG. 10. As a result, the portion of the wire cross section that engages the shell and the portion that engages the stripped wire ends can be interchanged, which can provide a further option for tailoring retention and gripping performance.

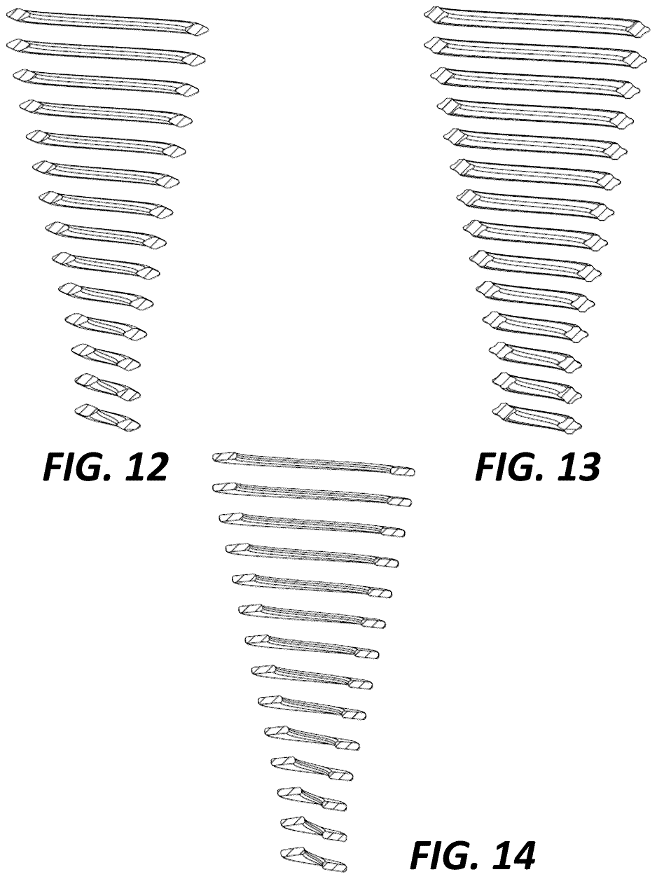

FIG. 12 illustrates a spring formed from a wire having the rounded-edge diamond-shaped cross-sectional shape shown in FIG. 3e. The cross section includes four linear sides joined by rounded edges and has perpendicular diameters of different lengths. When wound into the spring, selected rounded edges can be positioned for engagement with the shell and with stripped wire ends, while the elongated geometry of the diamond can provide directional stiffness and reduced material relative to a fully circular profile.

FIG. 13 illustrates a spring formed from a wire having the nub-ended star-shaped cross-sectional shape shown in FIG. 3f. This cross section generally corresponds to the star shape of FIG. 3a, with the difference that two opposed points are abbreviated into shorter nubs having substantially flat ends. When used in the spring, the remaining rounded points and the nubbed portions provide multiple engagement regions for contacting the shell and the stripped wire ends. The shortened nubs may also reduce material while preserving multiple contact features.

FIG. 14 illustrates a spring formed from a wire having the elongated rectangle-shaped cross-sectional shape shown in FIG. 3g. The elongated rectangular cross section includes two longer opposed sides and two shorter opposed sides joined at corners. The wire can be wound so that corners of the elongated rectangle are oriented toward the cavity of the spring and toward the shell, thereby allowing the corners to bite into the stripped wire ends and to resist movement relative to the shell. The elongated rectangle shape can provide a comparatively simple profile while still reducing material relative to larger-area common shapes.

In a first aspect of this disclosure, a twist-on wire connector is provided. The twist-on wire connector includes an insulating shell having a body wall and an end wall, the walls having internal surfaces and defining an internal cavity with an opening at one end for receiving a plurality of electrical wires, and a spring mounted in the internal cavity of the shell and engaging the internal surface of the body wall, the spring including a wound metal wire having a cross-section having at least one concave portion, radial asymmetry, bilateral asymmetry across a vertical line, or a height that is different from a width.

In an embodiment of the first aspect, the height of the cross-section is less than the width.

In an embodiment of the first aspect, the spring tapers from a large diameter end near the opening to a smaller diameter end near the end wall.

In an embodiment of the first aspect, the spring is in the form of an open helix in which windings do not overlap or abut each other.

In an embodiment of the first aspect, the spring is in the form of a closed helix in which windings overlap or abut each other.

In an embodiment of the first aspect, the internal surface of the body wall is threaded at a large end of the shell.

In an embodiment of the first aspect, the shell includes opposing wings adjacent the opening.

In an embodiment of the first aspect, the non-circular cross-section includes radial asymmetry.

In an embodiment of the first aspect, the non-circular cross-section includes bilateral asymmetry.

In an embodiment of the first aspect, the non-circular cross-section includes at least one concave portion.

In a second aspect of this disclosure, a spring for a twist-on wire connector is provided. The spring includes a wound metal wire defining a plurality of coils and extending from a larger diameter end to a smaller diameter end, and the wound metal wire has a cross-section having at least one concave portion, radial asymmetry, bilateral asymmetry, or a height that is different from a width.

In an embodiment of the second aspect, the height of the cross-section is less than the width.

In an embodiment of the second aspect, the large diameter end is configured to be positioned near an opening of the shell and the smaller diameter end is configured to be positioned adjacent an end wall of the shell.

In an embodiment of the second aspect, a taper of the plurality of coils is configured to generally match a conical shape of the internal surface of the shell.

In an embodiment of the second aspect, the plurality of coils are in the form of an open helix in which adjacent coils do not overlap or abut each other.

In an embodiment of the second aspect, the plurality of coils are in the form of a closed helix in which adjacent coils overlap or abut each other.

In an embodiment of the second aspect, the non-circular cross-section includes radial asymmetry.

In an embodiment of the second aspect, the non-circular cross-section includes bilateral asymmetry.

In an embodiment of the second aspect, the non-circular cross-section includes at least one concave portion.

In an embodiment of the second aspect, the non-circular cross-section is selected from the group consisting of a star shape, a half star shape, an arrowhead shape, a shark tooth shape, a rounded-edge diamond shape, a nub-ended star shape, and an elongated rectangle shape.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

What is claimed is:

1. A twist-on wire connector for joining the ends of a plurality of electrical wires, comprising:
an insulating shell having a body wall and an end wall, said walls having internal surfaces and defining an internal cavity with an opening at one end for receiving the electrical wires; and
a spring mounted in the internal cavity of the shell and engaging the internal surface of the body wall, the spring comprising a wound metal wire having a cross-section having:
at least one concave portion;
radial asymmetry;
bilateral asymmetry across a vertical line; or
a height that is different from a width.

2. The twist-on wire connector of claim 1, wherein the height of the cross-section is less than the width.

3. The twist-on wire connector of claim 1, wherein the spring tapers from a large diameter end near the opening to a smaller diameter end near the end wall.

4. The twist-on wire connector of claim 1, wherein the spring is in the form of an open helix in which windings do not overlap or abut each other.

5. The twist-on wire connector of claim 1, wherein the spring is in the form of a closed helix in which windings overlap or abut each other.

6. The twist-on wire connector of claim 1, wherein the internal surface of the body wall is threaded at a large end of the shell.

7. The twist-on wire connector of claim 1, wherein the shell comprises opposing wings adjacent the opening.

8. The twist-on wire connector of claim 1, wherein the non-circular cross-section includes radial asymmetry.

9. The twist-on wire connector of claim 1, wherein the non-circular cross-section includes bilateral asymmetry.

10. The twist-on wire connector of claim 1, wherein the non-circular cross-section includes at least one concave portion.

11. A spring for a twist-on wire connector, comprising:
a wound metal wire defining a plurality of coils and extending from a larger diameter end to a smaller diameter end; and
wherein the wound metal wire has a cross-section having:
at least one concave portion;
radial asymmetry;
bilateral asymmetry; or
a height that is different from a width.

12. The spring of claim 11, wherein the height of the cross-section is less than the width.

13. The spring of claim 11, wherein the large diameter end is configured to be positioned near an opening of the shell and the smaller diameter end is configured to be positioned adjacent an end wall of the shell.

14. The spring of claim 11, wherein a taper of the plurality of coils is configured to generally match a conical shape of the internal surface of the shell.

15. The spring of claim 11, wherein the plurality of coils are in the form of an open helix in which adjacent coils do not overlap or abut each other.

16. The spring of claim 11, wherein the plurality of coils are in the form of a closed helix in which adjacent coils overlap or abut each other.

17. The spring of claim 11, wherein the non-circular cross-section includes radial asymmetry.

18. The spring of claim 17, wherein the non-circular cross-section includes bilateral asymmetry.

19. The spring of claim 17, wherein the non-circular cross-section includes at least one concave portion.

20. The spring of claim 11, wherein the non-circular cross-section is selected from the group consisting of a star shape, a half star shape, an arrowhead shape, a shark tooth shape, a rounded-edge diamond shape, a nub-ended star shape, and an elongated rectangle shape.
